(19) United States
(12) Patent Application Publication
(10) Pub. No.: US 2014/0214263 A1
(43) Pub. Date: Jul. 31, 2014

(54) Method, device and computer program for assisting the maintenance of an aircraft system using a diagnostic assistance tool and experience feedback data

(71) Applicant: Airbus Operations (SAS), Toulouse (FR)

(72) Inventors: Patrice Boucher, Tournefeuille (FR); Nicolas Wacyk, Toulouse (FR)

(21) Appl. No.: 14/162,176

(22) Filed: Jan. 23, 2014

(30) Foreign Application Priority Data
Jan. 25, 2013 (FR) 1350675

(51) Int. Cl. B64F 5/00

(52) U.S. Cl. CPC B64F 5/0045
USPC 701/31.8

(57) ABSTRACT

Assistance in the maintenance of an aircraft system comprising a set of elements, means for detecting faults of elements or of functions implemented by elements and means for establishing a first level of diagnostic. After having detected a fault, a plurality of elements are identified, each element of that plurality of elements being liable to be at the origin of the detected fault, alone or in combination with at least one other element of that plurality of elements. A probability that the element considered is at the origin of said detected fault is then determined for each element of that plurality of elements.

### CROSS-REFERENCES TO RELATED APPLICATIONS

This application claims the benefit of the French patent application No. 1350675 filed on Jan. 25, 2013, the entire disclosures of which are incorporated herein by way of reference.

### BACKGROUND OF THE INVENTION

The present invention concerns the maintenance procedures for avionic computers in aircraft for identifying the equipment at the origin of failures detected in flight and more particularly a method, a device and a computer program for assisting the maintenance of an aircraft system using a diagnostic assistance tool and experience feedback data.

It is first of all to be recalled that there are several types of maintenance operations in aircraft. Among these, unplanned maintenance operations are carried out when equipment failures are detected during a flight. In addition to the confirmation of the detected failures, the unplanned maintenance operations are in particular directed to determining the cause of those failures in order to carry out a corresponding maintenance procedure. Such maintenance operations are carried out by maintenance operators when the aircraft is on the ground. They are generally based on information from logbooks, ECAM warnings (ECAM being an acronym for Electronic Centralized Aircraft Monitoring) and BITE messages (BITE being an acronym for Built-In Test Equipment).

It is also to be recalled that strong constraints, such as constraints of time (passenger waiting, costs of immobilization of the aircraft), working conditions (climate, day/night) and constraints linked to the type of aircraft and to the complexity of the maintenance procedures, are associated with those maintenance procedures. It is thus necessary to assist the operators in their work by avoiding unnecessary procedures and by optimizing their order.

Modern aircraft generally have an equipment monitoring system available for detecting faults in flight, and for performing a first level of diagnostic. For these purposes, a central maintenance system, for example a system of CMS type (CMS standing for Centralized Maintenance System) receives messages and establishes a diagnostic. The messages that are received and analyzed are for example the following:

messages of BITE type from equipment of the aircraft;

ECAM warnings from the cockpit; and

Observations input into the flight report by a member of the aircraft crew.

These messages result from faults. They are consolidated into the central maintenance system in order to produce a list of accusable items among which is the defective item or items at the origin of the detected fault or faults. Such a list is generally addressed, for example in PFR form (PFR standing for Post Flight Report), to a maintenance support team on the ground which analyzes and defines maintenance procedures to be carried out by operators, on the basis of procedures defined in a TSM (standing for Trouble-Shooting Manual).

A particular aim of the diagnostic function provided by the central maintenance system is to provide a list of faults capable of being repaired and to provide an explanation (in terms of repairable or non-repairable items) of the detected fault or faults.

By way of illustration, the system describes in patent application FR 2 966 616 is directed to a dynamic tool for assisting the diagnostic of an aircraft system, using failure condition graphs. This system makes it possible to establish a diagnostic of a complex system of an aircraft based on standard detected event notification messages and using modeling of the system which may also be used to perform checks and to conduct analyses relative to the complex system.

Diagnostic tools are increasingly reliable today and enable all the equipment that may be the cause of a detected fault to be accused. However, with the increasing number of components and the increase in the precision of diagnostic tools, the number of items which may be the cause of a detected fault increases. Therefore, to ensure that an item of equipment that is actually faulty is replaced, a maintenance operator must often perform several different tests in order to determine, within the list of accused equipment, that or those which are actually at the origin of the detected fault. This set of tests has a non-negligible consequence in terms of treatment time for the operator and may lead an impact on the authorization given to an aircraft to take off (known as a dispatch).

The invention enables at least one of the problems set forth above to be solved.

### SUMMARY OF THE INVENTION

The invention thus relates to a method for a computer for assisting the maintenance of a complex system of an aircraft comprising a set of items, means for detecting faults of items or of functions implemented by items and means for establishing a first level of diagnostic, this method comprising the steps of:

detecting a fault;

identifying a plurality of items of said set of items, each item of said plurality of items being liable to be at the origin of said detected fault, alone or in combination with at least one other item of said plurality of items; and

for each item of said plurality of items, determining a probability that the item considered is at the origin of said detected fault,

said steps being implemented in a system of an aircraft.

The method according to the invention thus makes it possible to optimize maintenance operations.

According to a particular embodiment, the method further comprises a step of identifying at least one item actually at the origin of said detected fault, identifiers of said at least one identified item and of said detected fault being used to update a database comprising at least one entry associating a fault identifier with a list of items liable to be at the origin of the identified fault and a probability, for each item of the list of items, that the corresponding item is at the origin of said identified fault. The method according to the invention thus makes it possible to optimize later maintenance operations.

Still according to a particular embodiment, the method further comprises a step of updating a temporary database, said database comprising at least one entry associating a fault identifier with a list of items liable to be at the origin of the identified fault and a probability, for each item of the list of items, that the corresponding item is at the origin of said identified fault, referred to as ground database, being updated on the basis of the content of said temporary database. The method further comprises, preferably, a step of sending said temporary database. The method according to the invention may thus be implemented easily without requiring a permanent communication link between the aircraft and a system on the ground.

Still according to a particular embodiment, said probability that the item considered is at the origin of said detected fault is determined on the basis of an aircraft database, the method further comprising a step of obtaining said aircraft database, said aircraft database corresponding to part of said ground database.

Said step of determining a probability that the item considered is at the origin of said detected fault may in particular be carried out during a diagnostic step or during a step of dynamic trouble-shooting.

The invention also relates to a method for a computer for assisting the maintenance of a complex system of an aircraft comprising a set of items, means for detecting faults of items or of functions implemented by items and means for establishing a first level of diagnostic, this method comprising the steps of:

obtaining an aircraft database, the content of said aircraft database corresponding to part of the content of a ground database comprising at least one entry associating a fault identifier with a list of items liable to be at the origin of the identified fault and a probability, for each item of the list of items, that the corresponding item is at the origin of said identified fault;

detecting a fault;

identifying a plurality of items of said set of items, each item of said plurality of items being liable to be at the origin of said detected fault, alone or in combination with at least one other item of said plurality of items;

for each item of said plurality of items, determining a probability that the item considered is at the origin of said detected fault, said probability that the item considered is at the origin of said detected fault being determined on the basis of said aircraft database.

identifying at least one item actually at the origin of said detected fault; and

updating a temporary database on the basis of identifiers of said at least one identified item and said detected fault, said ground database being updated on the basis of the content of said temporary database,

said steps of detecting a fault, identifying a plurality of items and of determining a probability being implemented in a system of an aircraft and the aircraft and temporary databases being stored in a system of said aircraft.

The method according to the invention thus makes it possible to optimize maintenance operations.

According to a particular embodiment, the method further comprises a step of receiving data from several temporary databases stored in systems of aircraft and updating said ground database, said step of updating said ground database being carried out in a system on the ground.

Still according to a particular embodiment said ground database comprises data relative to different types of aircraft.

The invention is also directed to a computer program comprising instructions adapted to the implementation of each of the steps of the method described earlier when said program is executed on a computer, to a device comprising means adapted to the implementation of each of the steps of that method and to an aircraft comprising that device.

The advantages procured by that computer program, that device and that aircraft are similar to those referred to above.

### BRIEF DESCRIPTION OF THE DRAWINGS

Other advantages, objects and features of the present invention will emerge from the following detailed description, given by way of non-limiting example, relative to the accompanying drawings in which:

FIG. 1 illustrates an example of an environment enabling the implementation of the invention according to a particular embodiment;

FIG. 2 illustrates an example of steps implemented to update a database of Temporary BITE history database type in an aircraft, and a database of Ground BITE history database type, on the ground, according to a particular embodiment;

FIG. 3 illustrates an example of steps implemented for updating a database of Flight BITE history database type on the basis of a database of Ground BITE history database type ;

FIG. 4 illustrates a first example of steps implemented in an avionic system to statistically optimize maintenance operations;

FIG. 5 illustrates a second example of steps implemented in an avionic system to statistically optimize maintenance operations; and

FIG. 6 illustrates an example of architecture of a device adapted to implement the invention according to a particular embodiment.

### DETAILED DESCRIPTION OF THE PREFERRED EMBODIMENTS

According to a particular embodiment, the invention is directed to combining information with items accused by a diagnostic tool, when faults are detected, the information representing, for each accused item, a probability of that item actually being implicated. Thus, with the aid of such information, an operator may give priority to one test procedure over another to determine, from a list of accused items, that or those which are actually at the origin of the detected fault or faults. The operator may thus avoid tests and save time.

As a matter of fact, not only may several items be, alternatively or in combination, at the origin of certain faults, but furthermore, most diagnostic tools enable a defective function to be determined but not the defective component or components (typically the LRU or LRUs implementing the defective function (LRU standing for Line Replaceable Unit)).

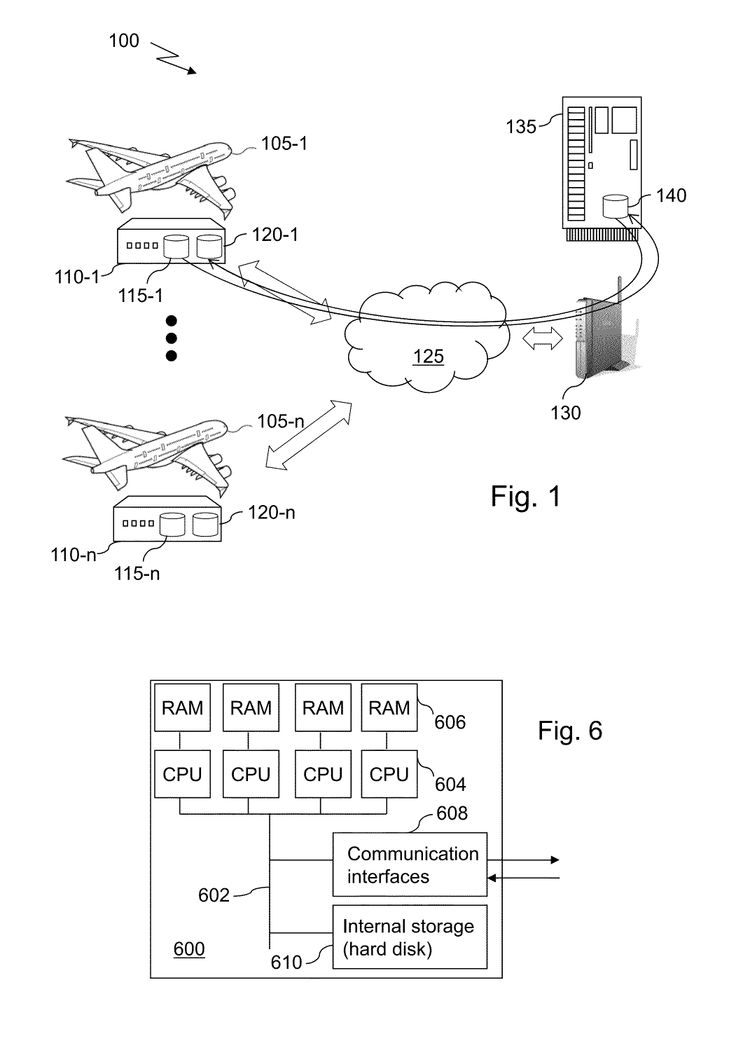

FIG. 1 illustrates an example environment enabling the implementation of the invention according to a particular embodiment.

As illustrated, the environment 100 comprises a set of aircraft referenced 105-1 to 105-n (only aircraft 105-1 and 105-n being represented here) each provided with an avionic system referenced 110, each comprising two generically referenced databases, 115 and 120. The avionic systems 110 may communicate with information processing systems on the ground via a communication network 125.

Furthermore, the communication network 125 is linked, via an access gateway 130, to a server 135 comprising a database 140. Avionic systems 110 may thus exchange data with the server 135 via the communication network 125 and the access portal 130.

It is observed here that according to a particular embodiment, a single database may be used in the server 135, without it being necessary to implement the databases 115 and 120, when a communication link that is permanent and real can be established between the avionic systems 110 and the server 135.

The database 140, also termed Ground BITE history database, preferably contains all the types of accusation possible for a set of aircraft (that is to say for all the faults capable of being detected), preferably for all the aircraft of the same manufacturer exploited by all the airline companies, as well as, for each accusable item, associated statistics (for example, the probability that the item actually is the item implicated in relation to a given fault). In order to profit from experience feedback relating to a high number of aircraft, this database is advantageously managed by the supplier or the manufacturer of the aircraft. Alternatively, this database may be managed in the form of one or more databases by companies exploiting the aircraft.

The databases 120, also called Flight BITE history databases, are synchronized with the database 140 and reproduce the information specific to the type of aircraft in which the database is hosted.

The databases 115, also termed Temporary BITE history database, are used to collect maintenance information of the aircraft hosting it and to send that information to the database 140.

A particular object of the databases 120 is to provide information to be combined with diagnostic information obtained, for example, by a central maintenance system of an aircraft. As indicated earlier, such information is typically probabilities that the accusable items actually are responsible for the detected faults.

Thus, by way of illustration, in the case of a detected fault for which the list of accusable items is of type “A or B or C”, in which A represents, for example, a CPIOM pin (CPIOM standing for Core Processing Input Output Module), B represents a cable connected to that pin and C represents an item of equipment connected to the CPIOM via that cable, the information to be combined with diagnostic data make it possible to define the probability that each of the items considered actually is the cause of the detected fault.

The result of such an combination may, for example, be the following: “A: 12.5% or B: 12.5% or C: 75%” meaning that the probability that item A or item B is implicated, is, for each of those items, 12.5% and the probability that the item C is implicated is 75%. Such an item of information enables a maintenance operator to commence the tests with item C. Thus, statistically, the time spent by the operator to test the potentially implicated items, further to detecting a fault, is reduced.

As indicated previously, the databases 115 are used to collect results of maintenance operations carried out. According to each type of accusation (detected fault), the database stores, at the end of maintenance procedures, the item or items that are actually implicated. The storage of this information enables the knowledge of the system to be enriched by experience feedback.

According to a particular embodiment, the information stored in a database 115 are automatically sent to the database 140 as soon as a connection can be established between the avionic system 110 hosting the database 115 and the server 135 hosting the database 140. Such a communication may be an air-ground communication or a ground-ground communication using a standard communication protocol, preferably secure.

The database 140 is thus updated with information received from the aircraft. Naturally, the database 140 may also be updated manually, for example when it has been observed several times that existing maintenance procedures are not adapted.

In turn, the databases 120 are regularly synchronized with the database 140, for example periodically or as soon as a change relative to an aircraft concerned is observed.

When a new aircraft is put into service, the database 140 is constructed by experience feedback. Thus, by way of illustration and continuing with the example of a fault for which the list of accusable items is of type “A or B or C”, wherein A represents a CPIOM pin, B represents a cable connected to that pin and C represents an item of equipment connected to the CPIOM via that cable, the experience feedback linked to the detection of that fault makes it possible to compute the probabilities defined earlier (the probability that item A or item B is implicated is, for each of those items, 12.5% and the probability that item C is implicated is 75%).

Such probabilities are, preferably, computed for each fault that is capable of being detected.

According to a particular embodiment, when the experience feedback is insufficient (below a predetermined threshold), the same level may be associated with each accusable item (even though the database 140 contains particular experience feedback information).

The information stored in the database 140 (and thus in the databases 120), typically representing probabilities that accusable items actually are responsible for detected faults, may be used in different manners, for example when establishing a diagnostic or after establishing a diagnostic.

Still according to a particular embodiment, the database of Ground BITE history database type, used to store a maintenance record for a high number of aircraft, preferably of different types, comprises two distinct parts:

a first part comprising data associated with each fault of a set of faults capable of being detected. Such data are, for example, the following:

an identifier of the fault considered, capable of being identified in a first level of diagnostic, based, in particular, on BITE messages, ECAM messages and observations by crew members.

an identifier of an aircraft type;

a threshold number of inputs defining the number of inputs on the basis of which the experience feedback data may be used (that is to say considered as sufficiently relevant to be taken into account in the maintenance procedures);

a number of inputs corresponding to the number of instances of experience feedback (that is to say to the number of times that the fault considered has been detected and that the items accused of and responsible for that fault have been identified). When that number attains the threshold number of inputs, the experience feedback data may be used in the maintenance procedures;

a level of confidence on experience feedback concerning the identified fault. It makes it possible, for example, to specify a level of confidence as to the percentages of accusation presented according to the number of inputs, the number of accusable items, fault levels of the accusable items, etc. and

a level of accusation for each accusable item with regard to the fault considered, that is to say, for example, a probability that an item having a given identifier is responsible for the fault considered; and

a second part comprising data relative to each item capable of being accused on detection of a fault. Such data are, for example, the following:

an identifier of the item considered;

an identifier of an aircraft type;

a list of faults capable of being detected of which the item considered is potentially the cause (in whole or in part); and

complementary information such as

a fault level (MTBF standing for mean time between failures);

release date of the item; and

number of hours of flight.

Naturally, other data may be stored in the database.

Thus, for each couple formed of an identifier of a fault capable of being detected and of a type of aircraft, the database of Ground BITE history database type makes it possible to define an order of accused items to test in order to statistically reduce the number of tests to perform. As described above, this database is updated regularly on the basis of experience feedback data.

Each database of Flight BITE history database type is extracted from the database of Ground BITE history database type. It reproduces only the data of the first part of data corresponding to a particular type of aircraft.

Each database of Temporary BITE history database type is used to update the database of Ground BITE history database type. It comprises data of the same type as those of the second part of the database of Ground BITE history database type, for a given aircraft type.

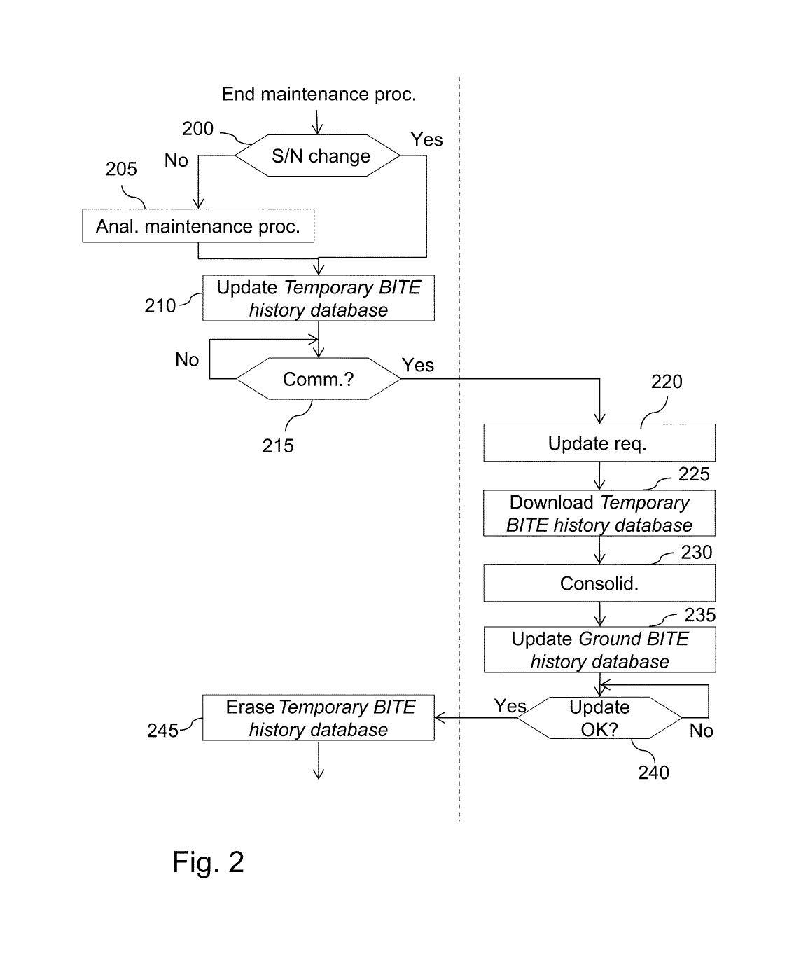

FIG. 2 illustrates an example of steps implemented to update a database of Temporary BITE history database type in an aircraft, and a database of Ground BITE history database type, on the ground, according to a particular embodiment.

It is observed here that such an algorithm also makes it possible to update and optimize maintenance procedures, for example maintenance procedures of DT-CT type (DT-CT standing for Dynamic Tree for Contextualized Troubleshooting) described, in particular, in patent application FR 2 917 521, using experience feedback and an analysis of maintenance procedures that led to the return to operational condition of an aircraft.

The steps represented in the left part of the Figure are implemented in an avionic system whereas the steps represented in the right part are implemented in a server on the ground.

After a maintenance procedure has been carried out in an aircraft, further to the detection of a fault, a first test is performed (step 200) to determine whether at least one item, typically an item of equipment, has been changed in the aircraft. An item of equipment is here a hardware or software component having a unique identifier (S/N, standing for Serial Number) each component that is capable of being changed in an aircraft having a separate identifier.

If no item has been changed, the maintenance procedure that enabled the return to operational state of the aircraft is analyzed (step 205). Such an analysis concerns, in particular the nature of operations carried out on the items which the maintenance procedure was directed to. These operations are, for example, a power cycle, a reset or dataloading of parameters/configuration.

The database of Temporary BITE history database type of the aircraft concerned is then updated (step 210). In particular, such an update may, if at least one item has been changed, consist in indicating the identifier of that item and, if no item has been changed, in indicating the identifier of the item or items to which were directed the maintenance procedure that enabled the identified fault to be corrected as well as the nature of the operations carried out.

A test is then carried out (step 215) to determine whether a connection may be established between the avionic system of the aircraft concerned, hosting the database of Temporary BITE history database type, and a server on the ground hosting the database of Ground BITE history database type to be updated.

If such a connection may be established, it is so established (it is for example a connection using a standard protocol, preferably secure) and an update request is sent, by the server on the ground hosting the database of Ground BITE history database type, to the avionic system of the aircraft concerned hosting the database of Temporary BITE history database type (step 220).

In response to that request, the database of Temporary BITE history database is sent and loaded into the server on the ground (step 225) and, where appropriate, its content is consolidated with that of similar databases sent and loaded from other aircraft (step 230).

The database of Ground BITE history database type is then updated with the received data and, where appropriate, consolidated (step 235). As indicated earlier, the database of Temporary BITE history database type comprises data such as those present in the second part of the database of Ground BITE history database type. These data are used to update those of the first part of that database.

By way of illustration, the database of Temporary BITE history database may comprise the following data:

INPUT<1>
S/N = x1
A/C type = y
Def. = Ext FMEA/PFC
MTBF = z1
Date_circ = dd1/mm1/yy1
Nb_H_vol= h1
INPUT<2>
S/N = x2
A/C type = y
Def. = Ext FMEA/PFC
MTBF = z2
Date_circ = dd2/mm2/yy2
Nb_H_vol= h2

where INPUT < > indicates an input of the database, S/N represents an item identifier, A/C type represents an aircraft type identifier, Def. represents a fault identifier, date_circ represents a release date and Nb_H_vol is a number of hours of flight.

Thus, according to this example, the database of Temporary BITE history database type comprises two entries linked to the fault Ext FMEA/PFC one of which designates the item x1 as being at the origin of the fault and the other x2.

These entries are used to update the database of Ground BITE history database type. Therefore, if the latter were to contain, in the first data part, the following input

INPUT<i>
Def. = Ext FMEA/PFC
A/C type = y
Threshold = [symbol]
Nb_inputs = NbIN
Niv_conf = [symbol]
List item
S/N = x1 ; Prob(S/N1) = prob1
S/N = x2 ; Prob(S/N1) = prob2
S/N = x3 ; Prob(S/N1) = prob3
S/N = x4 ; Prob(S/N1) = prob4

where INPUT < > indicates an input of the database, Def. represents a fault identifier, A/C type represents an identifier of an aircraft type, Threshold is the number of inputs from which the experience feedback data may be used, Nb_inputs is the number of experience feedbacks, Niv_conf is the level of confidence of the experience feedback, List_item is the list of the accusable items for the fault considered, S/N represents an item identifier and Prob(S/N) represents the level of accusation for the corresponding item,

this input may, after updating, be the following:

INPUT<i>
Def. = Ext FMEA/PFC
A/C type = y
Threshold = [symbol]
Nb_inputs = NbIN +2
Niv_conf = [symbol] [symbol]
List_item
S/N = x1 ; Prob(S/N1) = (prob1 / NbIN + 1) x (NbIN + 2) x [symbol]
S/N = x2 ; Prob(S/N1) = (prob2 / NbIN + 1) x (NbIN + 2) x [symbol]
S/N = x3 ; Prob(S/N1) = prob3 / NbIN x (NbIN + 2) x [symbol]
S/N = x4 ; Prob(S/N1) = prob4 / NbIN x (NbIN + 2) x [symbol] [symbol]
being a normalization factor.

After the database of Ground BITE history database type has been updated (step 240), the database of Temporary BITE history database type of the aircraft concerned is erased (step 245).

As described above, the management of the database of type Ground BITE history database may be performed at the level of the supplier or the manufacturer of the aircraft or at the level of a company exploiting those aircraft. The management of this database at the aircraft supplier or manufacturer level makes it possible to have a database of greater ambit, and, therefore, to have more reliable accusation statistics than those linked to a database managed at the level of a company exploiting aircraft (in particular in the case of small companies only possessing a few aircraft).

Furthermore, the management of that database at the aircraft supplier or constructor level makes it possible to use experience feedback data from flight tests. It also enables use, for new types of aircraft, of experience feedback data linked to earlier generations of aircraft to construct an initial version of the database, that version then being consolidated by experience feedback data linked to the type of aircraft concerned.

As described above, a central maintenance system does not generally make it possible to identify defective items further to the detection of a fault. Generally, the diagnostic result supplied in a PFR comprises a list of accusable items of which only some are actually at the origin of the detected fault or faults. The use of experience feedback data makes it possible to classify the list of accusable items, or more generally to refine that list, and thereby optimize the maintenance procedures. This use may be made on creation of the PFR or later, on the basis of its content. For these purposes, the central maintenance system or any other system of the aircraft having the task of correlating experience feedback data with a list of accusable items must comprise those data which, according to a particular embodiment, are contained in the database of Flight BITE history database type.

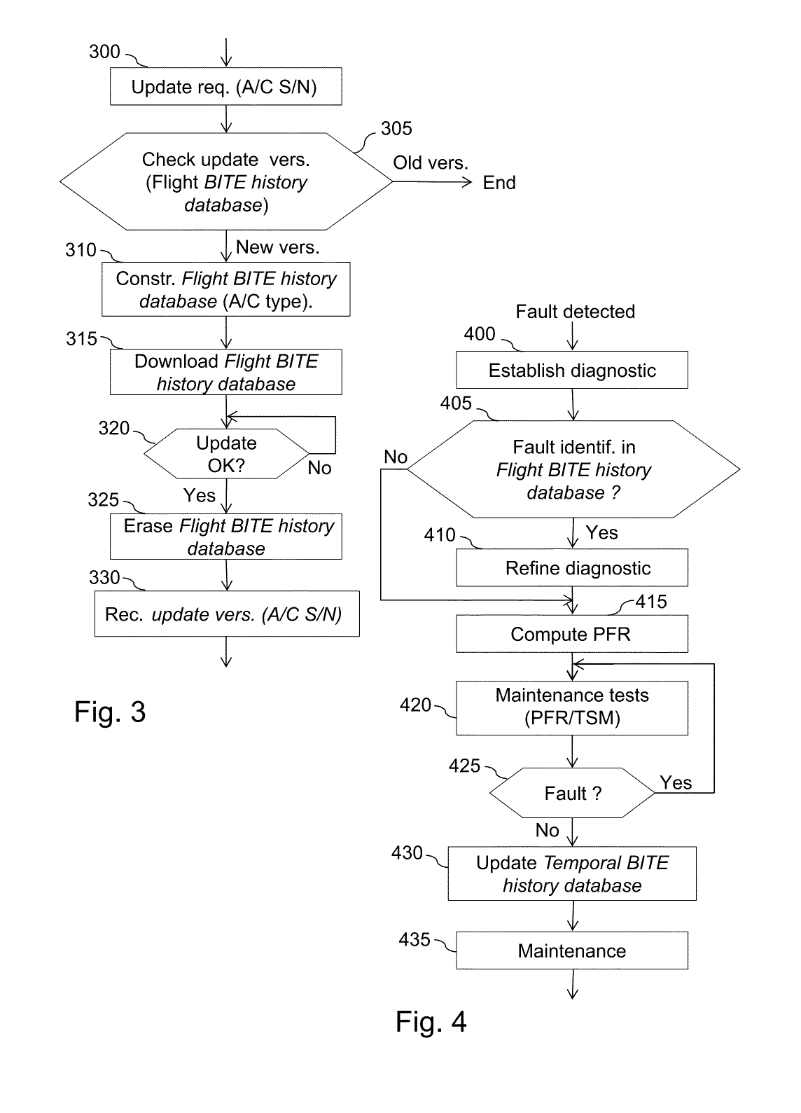

FIG. 3 illustrates an example of steps implemented for updating a database of Flight BITE history database type on the basis of a database of Ground BITE history database type.

The database of Flight BITE history database type may be updated periodically or according to predefined criteria. For these purposes, a connection is established between the avionic system hosting that database and the server on the ground hosting the database of Ground BITE history database type with which it must be synchronized. This connection is, for example, a connection using a standard protocol, preferably secure.

An update request is then sent by the avionic system of the aircraft concerned hosting the database of Flight BITE history database type to the server on the ground hosting the database of Ground BITE history database type (step 300). This request preferably comprises an identifier of the aircraft (A/C S/N) at the origin of the request.

A test is next carried out (step 305) to determine whether the version of the database of Flight BITE history database type is identical to that of the database of Ground BITE history database type. For these purposes, a version reference is associated with the database of Ground BITE history database type, that version being incremented on each update of this database. Furthermore, this database may comprise a third part of data associating, with each aircraft identifier, a Flight BITE history database type database version reference and the type of aircraft (A/C type). It is thus possible, on the basis of an identifier of the aircraft received in the updating request, to determine the version reference of the database of Flight BITE history database type.

If the version reference of the database of Flight BITE history database type is different from that of the database of Ground BITE history database type, a database of Flight BITE history database type, specific to the type of aircraft concerned is constructed (step 310). According to a particular embodiment, the database of Flight BITE history database type is an extraction of the database of Ground BITE history database type according to a particular aircraft type. It is stored temporarily in the server on the ground.

The constructed database is then sent and loaded into the avionic system concerned (step 315).

After the sending and loading (step 320), the constructed database is deleted from the server on the ground (step 325) and the version reference of the database of Flight BITE history database type for the aircraft concerned is updated, for example in the database of Ground BITE history database type.

After having been sent and loaded into an avionic system, the database of Flight BITE history database type may be used to classify a list of accusable items, or more generally to refine that list, and so optimize maintenance procedures. As described previously, when it is possible to create a permanent connection between an avionic system and a server on the ground, it is not necessary to use, in each aircraft, a database of Flight BITE history database type capable of being directly accessed and used.

FIG. 4 illustrates a first example of steps implemented in an avionic system to statistically optimize maintenance operations.

As illustrated, a first step is directed to establishing a diagnostic relative to a detected fault (step 400). The latter may be established using a standard tool such as a central system of CMS type.

A test is then carried out to determine whether the detected fault is present in the database of Flight BITE history database type (step 405). In the affirmative, the diagnostic is refined (step 410). As described above, this step may in particular consist of identifying the probability, for each accusable item of the diagnostic, of being at the origin of the detected fault. The accusable items may then be classified by decreasing probabilities such that the accusable items having the highest probabilities of being at the origin of the detected fault are considered first.

If the detected fault is not present in the database of Flight BITE history database type or after having refined the diagnostic, a flight report (PFR) is computed on the basis of the diagnostic which is, where possible, refined (step 415).

The flight report is then analyzed to define maintenance procedures on the basis of a trouble-shooting manual. The maintenance procedures defined are then executed to identify the accusable item or items at the origin of the detected fault (steps 420 and 425).

When the accusable item or items at the origin of the detected fault have been identified, the database of Temporary BITE history database type is updated (step 430), as described with reference to FIG. 2, and the actual maintenance operation is carried out (step 435). Alternatively, the actual maintenance operation may be carried out prior to or during the updating of the database of Temporary BITE history database type.

Whereas a central maintenance system of CMS type generally enables a diagnostic in PFR to be obtained, comprising relatively generic accusable items, new systems of ADA type (ADA being an acronym for Aircraft Diagnostic Agent) are appearing for enabling diagnostics to be established comprising more specific lists of accusable items. Such systems require the use of dynamic procedures (dynamic TSM procedures), the resolution of problems being performed dynamically depending on the accused items (DT-CT).

In such a context of static maintenance procedures (conventional TSM procedures), experience feedback data such as those contained in a database of Flight BITE history database type, may be used in relation to the diagnostic, as described with reference to FIG. 4, or in relation to a trouble-shooting procedure (as the latter is dynamic, it is possible to integrate therein experience feedback information to orient the resolution of the problem).

When experience feedback data are used in relation to the diagnostic, the ADA type central maintenance system correlates all the information coming from the different monitoring systems of the aircraft while, preferably, providing an interactive mode making it possible to confirm a fault and to confirm that it is no longer present after a maintenance operation.

The ADA system furthermore computes a second level of accusation by taking into account data from the database of Flight BITE history database type to refine the list of accusable items and thereby provide a maintenance operator with statistics on each of the accused items. As described above, such information makes it possible to orient the maintenance operator in order that, in a first phase, he gives priority to the items which are the most often at the origin of detected faults.

By way of illustration, the ADA system first of all supplies a list of items such as the following list: “A or B or (C and D)”.

Next, by using data from the database of Flight BITE history database type, the ADA system may refine the list of accusable items according to accusation statistics, it then being possible for that list to be expressed in the following manner: “A(60%) or B(35%) or (C and D)(5%)”.

A maintenance operator is thereby incited to test item A first of all.

Once again, the database of Ground BITE history database type, on the basis of which are derived databases of Flight BITE history database type, preferably uses data coming from a number of aircraft exploited by a high number of companies. The construction and updating of this database are advantageously carried out automatically by using results of maintenance operations, these results for example being stored in a database of Temporary BITE history database type sent to a server on the ground hosting the database of Ground BITE history database type.

Such a solution enables a maintenance operator to have full visibility of the equipment that are probably at the source of detected faults and to choose himself what equipment to test and replace first, taking into account that information and the ease and/or costs of the associated maintenance procedure.

Nevertheless, this solution requires human intervention which may be avoided by integrating the experience feedback data during the trouble-shooting phase.

Alternatively, when experience feedback data are used in relation to a trouble-shooting procedure, for example in a DT-CT type dynamic maintenance procedure system, that is to say in relation to the maintenance procedures, they are used to dynamically propose to a maintenance operator what procedures he should perform and in what order. Such an integrated solution enables a maintenance operator to directly see which is the best maintenance action to perform (as determined by the maintenance system).

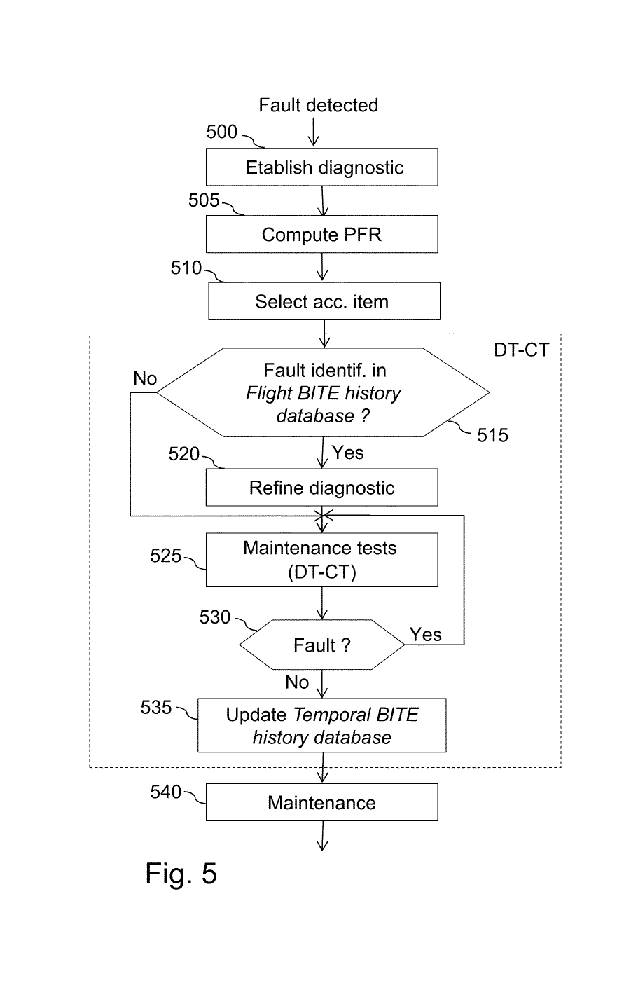

FIG. 5 illustrates a second example of steps implemented in an avionic system to statistically optimize maintenance operations.

As illustrated, a first step is directed to establishing a diagnostic relative to a detected fault (step 500). The latter may be established using a standard tool such as that described in patent application FR 2 966 616.

A flight report (PFR) is then computed on the basis of the diagnostic (step 505) and a list of accusable items arising from a fault is selected (step 510).

A test is then carried out to determine whether the detected fault is present in the database of Flight BITE history database type (step 515). In the affirmative, the diagnostic is refined (step 520). As described above, this step may in particular consist of identifying the probability, for each accusable item of the diagnostic, of being at the origin of the detected fault.

The trouble-shooting tool then guides the operator to identify the item or items at the origin of the detected fault by taking into account the items potentially implicated and the associated probabilities (steps 525 and 530).

When the accusable item or items at the origin of the detected fault have been identified, the database of Temporary BITE history database type is updated (step 535), as described with reference to FIG. 2, and the actual maintenance operation is carried out (step 540). Once again, the actual maintenance operation may be carried out prior to or during the updating of the database of Temporary BITE history database type.

As illustrated by the dashed line, steps 515 to 535 are implemented here in the trouble-shooting tool, for example the DT-CT.

FIG. 6 illustrates an example of architecture for a device adapted for the implementation of the invention or a part of the invention according to a particular embodiment, in particular the algorithms described with reference to FIGS. 2 to 5.

As illustrated, the device here comprises one or more microprocessors, local memories and a communication interface. More specifically, the device 600 here comprises a communication bus 602 to which there are connected:

Central Processing Units (CPUs) or microprocessors 604;

components of Random Access Memory (RAM) 606, comprising registers adapted to record variables and parameters created and modified during the execution of programs (as illustrated, each random access memory component may be associated with a microprocessor); and,

communication interfaces 608 adapted to send and to receive data.

The device 600 furthermore possesses here internal storage means 610, such as hard disks, able in particular to contain the executable code of programs.

The communication bus allows communication and interoperability between the different elements included in the device 600 or connected to it. The microprocessors 604 control and direct the execution of the instructions of portions of software code of the program or programs. On powering up, the program or programs which are stored in a non-volatile memory, for example a hard disk, are transferred into the random access memory 606.

Naturally, to satisfy specific needs, a person skilled in the art will be able to apply modifications in the preceding description. The present invention is not limited to the described embodiments, other variants and combinations of features are possible.

The present invention has been described and illustrated in the present detailed description with reference to the appended Figures. However, the present invention is not limited to the embodiments presented. Other variants and embodiments may be deduced and implemented by the person competent in the field of the invention on reading the present description and appended Figures.

In the claims, the term “comprise” does not exclude other elements or other steps. The indefinite article “a” does not exclude the plural. A single processor or several other units may be used to implement the invention. The different features presented and/or claimed may advantageously be combined. Their presence in the description or in different dependent claims, does not indeed exclude the possibility of combining them. The reference signs are not to be understood as limiting the scope of the invention.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A method for a computer for assisting the maintenance of a complex system of an aircraft comprising a set of items, means for detecting faults of items or of functions implemented by items and means for establishing a first level of diagnostic, this method comprising the steps of:
obtaining an aircraft database, the content of said aircraft database corresponding to part of the content of a ground database comprising at least one entry associating a fault identifier with a list of items liable to be at the origin of the identified fault and a probability, for each item of the list of items, that the corresponding item is at the origin of said identified fault;
detecting a fault;
identifying a plurality of items of said set of items, each item of said plurality of items being liable to be at the origin of said detected fault, alone or in combination with at least one other item of said plurality of items;
for each item of said plurality of items, determining a probability that the item considered is at the origin of said detected fault, said probability that the item considered is at the origin of said detected fault being determined on the basis of said aircraft database;
identifying at least one item actually at the origin of said detected fault; and
updating a temporary database on the basis of identifiers of said at least one identified item and said detected fault, said ground database being updated on the basis of the content of said temporary database,
said steps of detecting a fault, identifying a plurality of items and of determining a probability being implemented in a system of an aircraft and the aircraft and temporary databases being stored in a system of said aircraft.

2. A method according to claim 1, further comprising a step of sending said temporary database.

3. A method according to claim 1, wherein said step of determining a probability that the item considered is at the origin of said detected fault is carried out during a diagnostic step.

4. A method according to claim 1, wherein said step of determining a probability that the item considered is at the origin of said detected fault is carried out during a dynamic trouble-shooting step.

5. A method according to claim 1, further comprising a step of receiving data from several temporary databases stored in systems of aircraft and updating said ground database, said step of updating said ground database being carried out in a system on the ground.

6. A method according to claim 5, wherein said ground database comprises data relative to different types of aircraft.

7. A computer program comprising instructions adapted for the carrying out of each of the steps of the method according to claim 1 when said program is executed on a computer.

8. A device comprising a computer configured for carrying out each of the steps of the method according to claim 1.

9. An aircraft comprising the device according to claim 8.
